(19) United States
(12) Patent Application Publication
(10) Pub. No.: US 2008/0068760 A1
(43) Pub. Date: Mar. 20, 2008

(54) Thin film magnetic head, magnetic recorder, and method for manufacturing thin film magnetic head

(75) Inventor: Song Woo Suk, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: Fujitsu Limited, Kawasaki-shi (JP)

(21) Appl. No.: 11/788,989

(22) Filed: Apr. 23, 2007

(30) Foreign Application Priority Data
Sep. 15, 2006 (JP) 2006-250168

(51) Int. Cl. G11B 5/33

(52) U.S. Cl. 360/313

(57) ABSTRACT

A thin film magnetic head includes ferromagnetic films sandwiching a magnetoresistance effect element to stabilize the magnetic domain control of a free layer and thereby prevents the side reading from a track adjacent to a target regenerative track (side track). A method for manufacturing the thin film magnetic head and a magnetic recorder including the thin film magnetic head are also provided.

The thin film magnetic head includes a magnetoresistance effect element, ferromagnetic films sandwiching the magnetoresistance effect element and controlling the magnetic domains of the magnetoresistance effect element, and external-magnetic-field blockers to cover the ferromagnetic films at a floating plane side of the magnetoresistance effect element

### BACKGROUND OF THE INVENTION

1. Field of the Invention

The present invention relates to a thin film magnetic head that includes a magnetoresistance effect element and ferromagnetic films sandwiching the magnetoresistance effect element and controlling the magnetic domains of the magnetoresistance effect element, a method for manufacturing the thin film magnetic head, and a magnetic recorder including the thin film magnetic head.

2. Description of the Related Art

In general, thin film magnetic heads for use in magnetic recording and reproduction include spin-valve magnetoresistance effect elements (read elements) utilizing a magnetoresistance effect resulting from spin-dependent scattering. The magnetoresistance effect elements are mainly of a current-in-plane (CIP) type, in which a sense current flows parallel to the elements. Even with the thin film magnetic heads of the CIP type, the detectivity of the magnetoresistance change tends to decrease at a track width of 0.1 μm or less. To improve the detectivity, thin film magnetic heads of a current-perpendicular-to-plane (CPP) type, in which a sense current flows perpendicularly to the elements, have been employed. Thin film magnetic heads of a tunnel type, which utilize the tunneling of a sense current, have also been employed.

FIG. 8 is a cross-sectional view of a thin film magnetic head of the CIP type. The thin film magnetic head includes a lower shielding layer 10, an upper shielding layer 20, a core portion 12 including a fixed magnetization layer, and a free layer (free magnetic layer) 14. In the free layer 14, the direction of a magnetic pole can be changed by an external magnetic field. The core portion 12 and the free layer 14 constitute a magnetoresistance effect element 8. Ferromagnetic films 16a and 16b control the magnetic domains of the free layer 14. The ferromagnetic films 16a and 16b are formed on both inclined sides of the magnetoresistance effect element 8. Electrodes 17a and 17b are disposed between the ferromagnetic films 16a and 16b and the upper shielding layer 20. Insulating films 18 are disposed at an interface between the ferromagnetic films 16a and 16b and the lower shielding layer 10 and at an interface between the electrodes 17a and 17b and the upper shielding layer 20. As indicated by an arrow, a sense current flows parallel to a magnetoresistance effect film of the magnetoresistance effect element 8 to detect a magnetic signal.

FIG. 9 is a cross-sectional view of a thin film magnetic head of the CPP type. In the thin film magnetic head of the CPP type, the electrodes 17a and 17b are not formed and only ferromagnetic films 16a and 16b are formed on both sides of a core portion 12. Insulating films 18 are disposed at interfaces among the ferromagnetic films 16a and 16b, the core portion 12, a lower shielding layer 10, and an upper shielding layer 20. As indicated by an arrow, a sense current flows from the upper shielding layer 20 to the lower shielding layer 10 perpendicularly to a magnetoresistance effect film of the magnetoresistance effect element 8 to detect a magnetic signal. A thin film magnetic head including a magnetoresistance effect element (read element) of a tunnel type has the same structure as that illustrated in FIG. 9.

FIG. 10 is an exploded view of a thin film magnetic head including a magnetoresistance effect element 8 of a CPP or tunnel type, viewed from a floating plane 4 in the depth direction. As shown in FIG. 10, a linear magnetoresistance effect element 8 is formed on a lower shielding layer 10 perpendicular to the floating plane 4. Ferromagnetic films 16a and 16b are disposed between the upper shielding layer 20 and the lower shielding layer 10 and sandwich the magnetoresistance effect element 8.

In FIG. 10, insulating films 18 are omitted.

When the track width and the track pitch of a magnetic recording medium is reduced to increase the magnetic recording density of the magnetic medium, the thin film magnetic heads illustrated in FIGS. 8 to 10 may read not only magnetic information from a target reproducing track of the magnetic recording medium, but also magnetic information from a track adjacent to the target reproducing track (side track). Thus, the reproduction signal may include a noise. This is called side reading. The side reading occurs when the track width and the track pitch are smaller than the core width of a magnetoresistance effect element. The track width and the track pitch of a magnetic recording medium, therefore, cannot further be reduced. Hence, the magnetic recording density cannot be increased.

Although the core width of a magnetoresistance effect element of the thin film magnetic heads illustrated in FIGS. 8 to 10 may be reduced, this is limited by the manufacturability of the magnetoresistance effect element.

To reduce a magnetic signal noise from a side track to achieve a greater magnetic recording density, Japanese Unexamined Patent Application Publication No. 2005-353666 proposes a thin film magnetic head that can block a magnetic flux from a side track. As illustrated in FIGS. 11 and 12, this thin film magnetic head includes shields 30a and 30b formed of soft magnetic films on both sides of a magnetoresistance effect element 9 in place of the ferromagnetic films 16a and 16b illustrated in FIGS. 8 to 10.

Furthermore, a free layer of the thin film magnetic head according to this patent document has a layered ferri structure consisting of a first free layer 14a, an antiferromagnetic coupling layer 15, and a second free layer 14b to control the magnetic domains of the free layer, instead of using the ferromagnetic films.

Japanese Unexamined Patent Application Publication No. 2003-264324 describes a thin film magnetic head that includes a ferromagnetic film (bias layer) in a magnetoresistance effect element (read element) to control the magnetic domains of a free layer.

However, the magnetic domains of the free layer having the layered ferri structure in the thin film magnetic head according to Japanese Unexamined Patent Application Publication No. 2005-353666 (FIGS. 11 and 12) are less stable than those in the thin film magnetic head including the ferromagnetic films on both sides of the magnetoresistance effect element (FIGS. 8 and 9).

In the thin film magnetic head according to Japanese Unexamined Patent Application Publication No. 2003-264324, from a practical standpoint, to stabilize the magnetic domain control of the free layer, a ferromagnetic film (bias layer) having a thickness of at least about 30% of the thickness of the entire read element in the track direction must be formed. Thus, the ferromagnetic film increases the thickness of the read element. An increase in the thickness of the read element causes an increase in readable bit length in the track direction of a recording medium, thus preventing denser magnetic recording and reproduction.

### SUMMARY OF THE INVENTION

Accordingly, it is an object of the present invention to provide a thin film magnetic head that includes ferromagnetic films sandwiching a magnetoresistance effect element to stabilize the magnetic domain control of a free layer and thereby prevents the side reading from a track adjacent to a target reproducing track (side track). It is another object of the present invention to provide a method for manufacturing the thin film magnetic head. It is still another object of the present invention to provide a magnetic recorder including the thin film magnetic head.

A thin film magnetic head according to the present invention has the following structure to solve the problems described above.

A thin film magnetic head according to the present invention includes a magnetoresistance effect element, ferromagnetic films sandwiching the magnetoresistance effect element and controlling the magnetic domains of the magnetoresistance effect element, and external-magnetic-field blockers to cover the ferromagnetic films at a floating plane side of the magnetoresistance effect element.

While the ferromagnetic films sandwiching the magnetoresistance effect element appropriately control the magnetic domains of a free layer, the external-magnetic-field blockers cover the floating plane side of the ferromagnetic films (magnetic recording medium side) to block a magnetic flux from a side track and thereby prevent the side reading.

Furthermore, the external-magnetic-field blockers may have a wedge shape, and the tip among the tips of each of the external-magnetic-field blockers having the most acute angle faces the magnetoresistance effect element.

In this structure, because the ferromagnetic films sandwich the magnetoresistance effect element from the top down to the neighborhood of the floating plane, the magnetic domain control of the free layer can appropriately be maintained.

Furthermore, the ferromagnetic films may sandwich the magnetoresistance effect element also in the vicinity of the floating plane of the magnetoresistance effect element.

In this structure, because the ferromagnetic films sandwich the magnetoresistance effect element from the top down to the floating plane, the magnetic domain control of the free layer can further appropriately be maintained.

The thin film magnetic head according to the present invention may further include electrode films that sandwich the magnetoresistance effect element and that are electrically connected with the magnetoresistance effect element. The external-magnetic-field blockers may cover the electrode films at a floating plane side of the magnetoresistance effect element.

The external-magnetic-field blockers may be insulated from the electrode films.

A magnetic recorder according to the present invention has the following structure to solve the problems described above.

That is, a magnetic recorder according to the present invention reads information from a recording medium using a thin film magnetic head that includes a magnetoresistance effect element, ferromagnetic films sandwiching the magnetoresistance effect element and controlling the magnetic domains of the magnetoresistance effect element, and external-magnetic-field blockers to cover the ferromagnetic films at a floating plane side of the magnetoresistance effect element.

In the thin film magnetic head, while the ferromagnetic films sandwiching the magnetoresistance effect element appropriately control the magnetic domains of a free layer, the external-magnetic-field blockers cover the floating plane side of the ferromagnetic films (magnetic recording medium side) to block a magnetic flux from a side track and thereby prevent the side reading. Thus, the resulting reproduction signal does not include a noise caused by the side reading. Hence, the magnetic recorder according to the present invention has appropriate reading performance.

A method for manufacturing a thin film magnetic head according to the present invention includes the following steps to solve the problems described above.

That is, a method for manufacturing a thin film magnetic head according to the present invention includes the steps of producing a magnetoresistance effect element, producing ferromagnetic films to sandwich the magnetoresistance effect element and control the magnetic domains of the magnetoresistance effect element, producing external-magnetic-field blockers for covering the ferromagnetic films at a floating plane side of the magnetoresistance effect element, and exposing a floating plane of the magnetoresistance effect element by polishing.

According to this method, a thin film magnetic head in which ferromagnetic films are covered at a floating plane side with external-magnetic-field blockers is appropriately manufactured.

The step for producing external-magnetic-field blockers may include removing portions of the ferromagnetic films in contact with a floating plane to form the external-magnetic-field blockers in the resulting spaces.

A thin film magnetic head according to the present invention includes ferromagnetic films on both sides of the magnetoresistance effect element to stabilize the magnetic domain control of a free layer and prevent the side reading from a track adjacent to a target reproducing track (side track).

Furthermore, the resulting reproduction signal does not include a noise caused by the side reading. Hence, the magnetic recorder according to the present invention has appropriate reading performance.

According to a method for manufacturing a thin film magnetic head according to the present invention, a thin film magnetic head in which ferromagnetic films are covered at a floating plane side with external-magnetic-field blockers is appropriately manufactured.

### BRIEF DESCRIPTION OF THE DRAWINGS

FIG. 1 is an exploded view of a thin film magnetic head according to an embodiment of the present invention;

FIG. 2 is a schematic view of a floating plane of a thin film magnetic head according to an embodiment of the present invention;

FIG. 3 is a schematic view of a floating plane of a thin film magnetic head according to another embodiment of the present invention;

FIGS. 4A to 4F are schematic views illustrating a method for manufacturing a thin film magnetic head according to an embodiment of the present invention;

FIGS. 5A to 5C are schematic top views illustrating a method for manufacturing a thin film magnetic head according to an embodiment of the present invention;

FIGS. 6A to 6F are schematic views illustrating a method for manufacturing a thin film magnetic head according to an embodiment of the present invention;

FIG. 7 is a schematic view of a magnetic recorder according to an embodiment of the present invention;

FIG. 8 is a cross-sectional view of a thin film magnetic head of a CIP type;

FIG. 9 is a cross-sectional view of a thin film magnetic head of a CPP type;

FIG. 10 is an exploded view of an existing thin film magnetic head;

FIG. 11 is a cross-sectional view of an existing thin film magnetic head; and

FIG. 12 is a cross-sectional view of another existing thin film magnetic head.

### DESCRIPTION OF THE PREFERRED EMBODIMENTS

A thin film magnetic head according to the present invention, the method for manufacturing the thin film magnetic head, and a magnetic recorder according to the present invention are described in detail below.

### (Thin Film Magnetic Head)

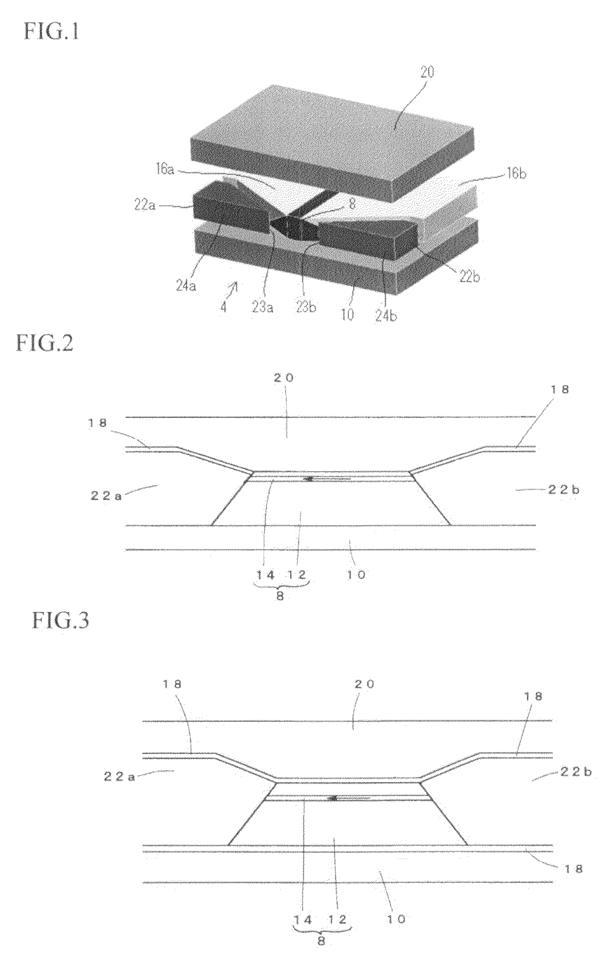

FIG. 1 is an exploded view of a thin film magnetic head according to the present embodiment, viewed from a floating plane 4 in the depth direction. The thin film magnetic head includes a magnetoresistance effect element (read element) 8 of a CPP or tunnel type. FIG. 2 is a schematic view of a floating plane 4 of the thin film magnetic head according to the present embodiment.

A cross-section of the thin film magnetic head parallel to the floating plane 4 (not a cross-section of external-magnetic-field blockers 22a and 22b described below (see FIG. 1)) has the same structure as that illustrated in FIG. 9.

In FIGS. 1, 2, and 9, a thin film magnetic head includes a lower shielding layer 10, an upper shielding layer 20, a core portion 12 including a fixed magnetization layer, and a free layer (free magnetic layer) 14, which responds to external magnetism. The core portion 12 and the free layer 14 constitute a magnetoresistance effect element 8. Ferromagnetic films 16a and 16b (hard bias films) control the magnetic domains of the free layer 14. The ferromagnetic films 16a and 16b are formed on both inclined sides of the magnetoresistance effect element 8. Insulating films 18 are disposed at interfaces among the ferromagnetic films 16a and 16b, the core portion 12, a lower shielding layer 10, and an upper shielding layer 20. As indicated by an arrow in FIG. 9, a sense current flows perpendicularly to a magnetoresistance effect film of the magnetoresistance effect element 8 to detect a magnetic signal.

In FIG. 1, insulating films 18 are omitted.

As illustrated in FIGS. 1 and 2, in the thin film magnetic head, the end faces of the ferromagnetic films 16a and 16b at the floating plane 4 are covered with the external-magnetic-field blockers 22a and 22b. As illustrated in FIG. 1, the external-magnetic-field blockers 22a and 22b have a wedge shape. The tip among the tips of each of the external-magnetic-field blockers having the most acute angle faces the magnetoresistance effect element 8. In other words, the external-magnetic-field blockers 22a and 22b are tapered (wedge-shaped) to edges 23a and 23b that face the magnetoresistance effect element 8. The external-magnetic-field blockers 22a and 22b have an acute angle at the edges 23a and 23b. Exposed surfaces 24a and 24b of the external-magnetic-field blockers 22a and 22b are flush with the floating plane 4 (in other words, the exposed surfaces 24a and 24b constitute the floating plane 4).

Thus, the ferromagnetic films 16a and 16b sandwich the magnetoresistance effect element 8 also in the vicinity of the floating plane 4 of the magnetoresistance effect element 8. Hence, the magnetic domain control of the free layer 14 of the magnetoresistance effect element 8 is appropriately be maintained.

In a thin film magnetic head of the CPP type according to the present invention, the distance between the upper shielding layer 20 and the lower shielding layer 10 is 60 nm, and the readable bit length in the track direction is 30 nm. As in the structure according to Japanese Unexamined Patent Application Publication No. 2003-264324, when a ferromagnetic film (bias layer) is placed on a read element, a ferromagnetic film having a thickness of at least 20 to 30 nm must be placed on a read element. In this case, the distance between the upper shield and the lower shield is 80 to 90 nm, and the readable bit length in the track direction is about 40 to 45 nm. Thus, a thin film magnetic head of the CPP type according to the present invention can read a magnetic recording medium having a recording and reproduction density at least 30% as high as that in the thin film magnetic head according to Japanese Unexamined Patent Application Publication No. 2003-264324.

A thin film magnetic head including a CIP type magnetoresistance effect element according to an embodiment of the present invention is described below.

FIG. 3 is a schematic view of a floating plane 4 of a thin film magnetic head including a CIP type magnetoresistance effect element 8 according to the present embodiment. A cross-section of the thin film magnetic head parallel to the floating plane 4 (not a cross-section of external-magnetic-field blockers 22a and 22b) has the same structure as that illustrated in FIG. 8.

In FIGS. 3 and 8, the thin film magnetic heads include a lower shielding layer 10, an upper shielding layer 20, a core portion 12 including a fixed magnetization layer, and a free layer (free magnetic layer) 14. The core portion 12 and the free layer 14 constitute a magnetoresistance effect element 8. Ferromagnetic films 16a and 16b control the magnetic domains of the free layer 14. The ferromagnetic films 16a and 16b are formed on both inclined sides of the magnetoresistance effect element 8. Electrode films 17a and 17b are disposed between the ferromagnetic films 16a and 16b and the upper shielding layer 20. Insulating films 18 are disposed at an interface between the ferromagnetic films 16a and 16b and the lower shielding layer 10 and at an interface between the electrode films 17a and 17b and the upper shielding layer 20. As indicated by an arrow in FIG. 8, a sense current flows parallel to a magnetoresistance effect film of the magnetoresistance effect element 8 to detect a magnetic signal.

As illustrated in FIG. 3, in the thin film magnetic head, the end faces of the ferromagnetic films 16a and 16b and the electrode films 17a and 17b at the floating plane 4 are covered with the external-magnetic-field blockers 22a and 22b.

In the thin film magnetic head including a CIP type magnetoresistance effect element, the shape and the structure of the external-magnetic-field blockers 22a and 22b are the same as those in the thin film magnetic head of a CPP or tunnel type and will not be described further.

### (Method for Manufacturing Thin Film Magnetic Head)

The following embodiment describes a method for manufacturing thin film magnetic head including a magnetoresistance effect element 8 of a CPP or tunnel type illustrated in FIGS. 1, 2, and 9.

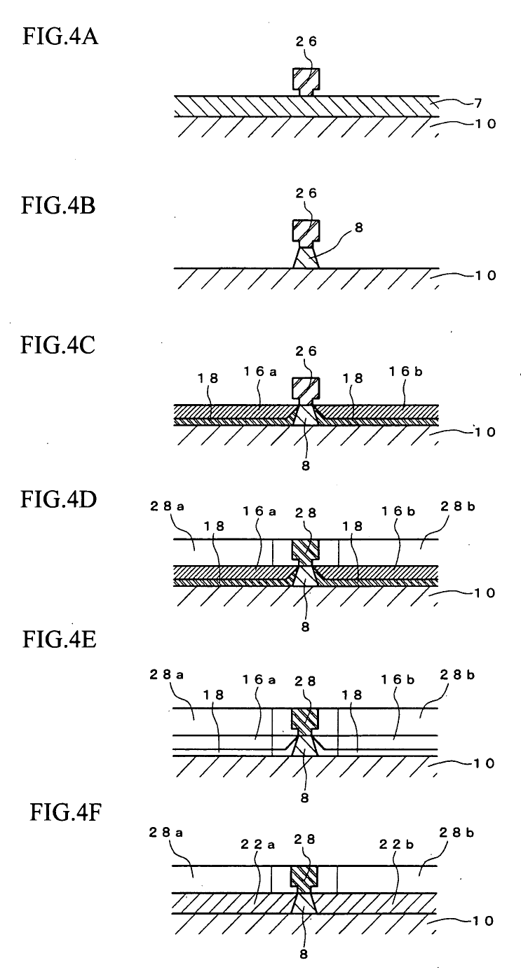

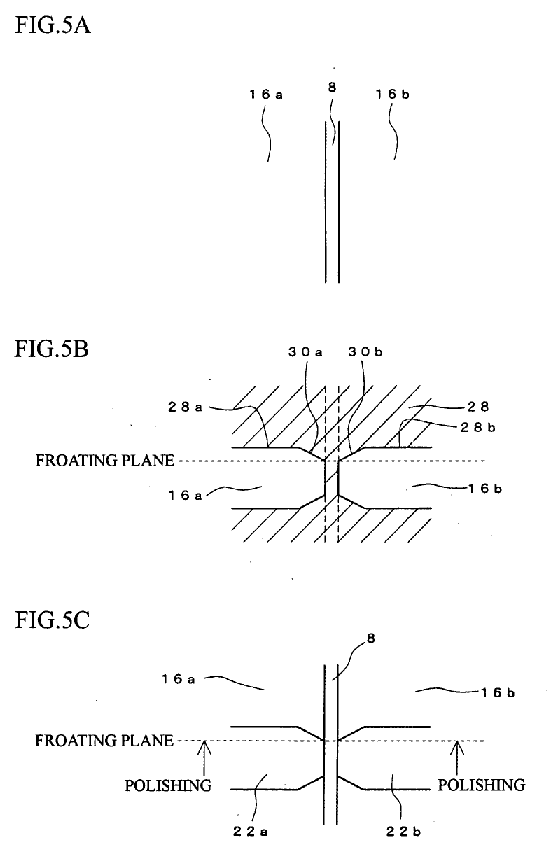

As illustrated in FIG. 4A, a magnetoresistance effect element layer 7 of a CPP or tunnel type is formed on a lower shielding layer 10. A first resist layer 26 is formed on the magnetoresistance effect element layer 7 by photolithography. The first resist layer 26 is formed at a position where a magnetoresistance effect element 8 of a thin film magnetic head is to be formed. The first resist layer 26 includes two different photo first resist sublayers, in which a lower sublayer is narrower than an upper sublayer.

As illustrated in FIG. 4B, a portion of the magnetoresistance effect element layer 7 that is not covered with the first resist layer 26 is removed by ion beam etching to form the magnetoresistance effect element 8.

As illustrated in FIG. 4C, insulating films 18 are formed on the lower shielding layer 10 and both sides of the magnetoresistance effect element 8. Ferromagnetic films 16a and 16b are formed on the insulating films 18 by sputtering.

The first resist layer 26 is removed.

FIGS. 5A to 5C are schematic top views of a thin film magnetic head during the manufacturing process. FIG. 5A illustrates the thin film magnetic head after the first resist layer 26 is removed. The magnetoresistance effect element 8 and the ferromagnetic films 16a and 16b are exposed at the top surface.

As illustrated in FIGS. 4D and 5B, a second resist layer 28 is formed on the magnetoresistance effect element 8 and ferromagnetic films 16a and 16b. Openings 28a and 28b are formed in the second resist layer 28 by photolithography to expose part of the ferromagnetic films 16a and 16b. In FIG. 5B, oblique lines designate the second resist layer 28.

The openings 28a and 28b are formed at positions where external-magnetic-field blockers 22a and 22b are to be formed in the downstream process. The ferromagnetic films 16a and 16b are exposed from a position where the floating plane 4 is to be formed in the downstream process to a position shifted slightly in the height direction of the thin film magnetic head. The openings 28a and 28b include tapered portions 29a and 29b on the sides of the magnetoresistance effect element 8. The tapered portions 29a and 29b are tilted relative to the floating plane 4 and correspond to tapered portions of the external-magnetic-field blockers 22a and 22b to be formed on the floating plane 4 in the downstream process.

As illustrated in FIG. 4E, portions of the ferromagnetic films 16a and 16b and the insulating films 18 exposed through the openings 28a and 28b are removed by ion beam etching.

As illustrated in FIG. 4F, external-magnetic-field blockers 22a and 22b are formed on portions of the lower shielding layer 10 exposed through the openings 28a and 28b (portions at which the ferromagnetic films 16a and 16b and the insulating films 18 are removed). The external-magnetic-field blockers 22a and 22b cover the end faces of the ferromagnetic films 16a and 16b at the floating plane side.

As illustrated in FIGS. 2 and 9, insulating films 18 are formed on the ferromagnetic films 16a and 16b and the external-magnetic-field blockers 22a and 22b. An upper shielding layer 20 is formed on the insulating films 18 and the magnetoresistance effect element 8.

As illustrated in FIG. 5C, after the lamination process, the ferromagnetic films 16a and 16b and the external-magnetic-field blockers 22a and 22b are partly removed by chemical mechanical polishing (CMP) to form the floating plane 4.

A thin film magnetic head including external-magnetic-field blockers 22a and 22b is thus manufactured.

The following embodiment describes a method for manufacturing a thin film magnetic head including a CIP type magnetoresistance effect element 8 illustrated in FIGS. 3 and 8.

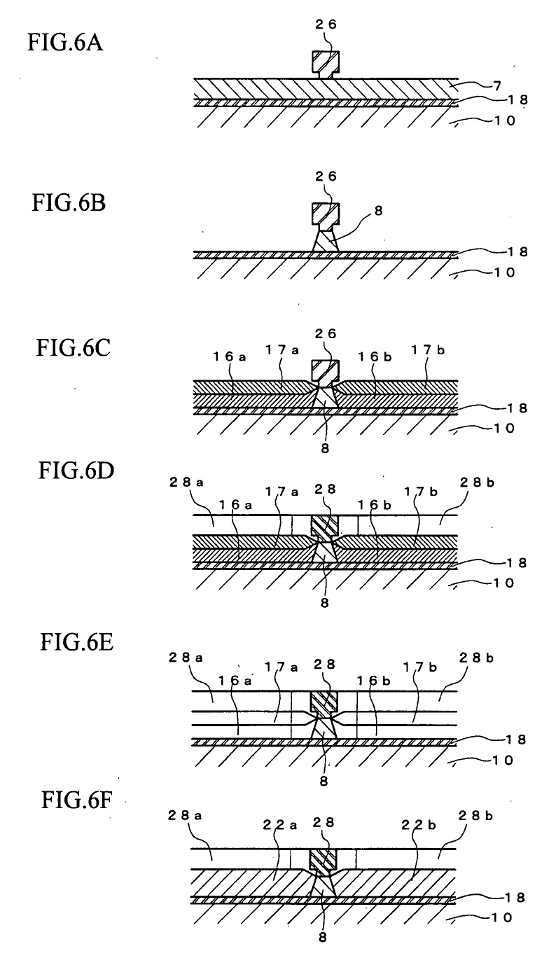

As illustrated in FIG. 6A, an insulating film 18 is formed on a lower shielding layer 10. A CIP type magnetoresistance effect element layer 7 is formed on the insulating film 18. A first resist layer 26 is formed on the magnetoresistance effect element layer 7 by photolithography. The first resist layer 26 is formed at a position where a magnetoresistance effect element 8 of a thin film magnetic head is to be formed. The first resist layer 26 includes two different photo first resist sublayers, in which a lower sublayer is narrower than an upper sublayer.

As illustrated in FIG. 6B, a portion of the magnetoresistance effect element layer 7 that is not covered with the first resist layer 26 is removed by ion beam etching to form the magnetoresistance effect element 8.

As illustrated in FIG. 6C, ferromagnetic films 16a and 16b are formed on the insulating film 18 and both sides of the magnetoresistance effect element 8 by sputtering. Electrode films 17a and 17b are formed on the ferromagnetic films 16a and 16b. The electrode films 17a and 17b may be formed of an electroconductive substance, such as gold.

The first resist layer 26 is removed.

As illustrated in FIG. 6D, a second resist layer 28 is formed on the magnetoresistance effect element 8 and the electrode films 17a and 17b. Openings 28a and 28b are formed in the second resist layer 28 by photolithography to expose part of the electrode films 17a and 17b. The shape and other properties of the openings 28a and 28b are the same as those in the method for manufacturing a thin film magnetic head including a CPP or tunnel type magnetoresistance effect element 8 and will not be described further.

As illustrated in FIG. 6E, portions of the electrode films 17a and 17b and the ferromagnetic films 16a and 16b exposed through the openings 28a and 28b are removed by ion beam etching.

As illustrated in FIG. 6F, external-magnetic-field blockers 22a and 22b are formed on portions of the insulating film 18 exposed through the openings 28a and 28b. The external-magnetic-field blockers 22a and 22b cover the end faces of the ferromagnetic films 16a and 16b at the floating plane side.

As illustrated in FIGS. 3 and 8, an insulating film 18 is formed on the electrode films 17a and 17b, the external-magnetic-field blockers 22a and 22b, and the magnetoresistance effect element 8. An upper shielding layer 20 is formed on the insulating film 18.

After the lamination process, the ferromagnetic films 16a and 16b and the external-magnetic-field blockers 22a and 22b are partly removed by chemical mechanical polishing (CMP) to form the floating plane 4.

A thin film magnetic head including external-magnetic-field blockers 22a and 22b is thus manufactured.

### (Magnetic Recorder)

The following embodiment describes a magnetic recorder including the thin film magnetic head according to the present invention.

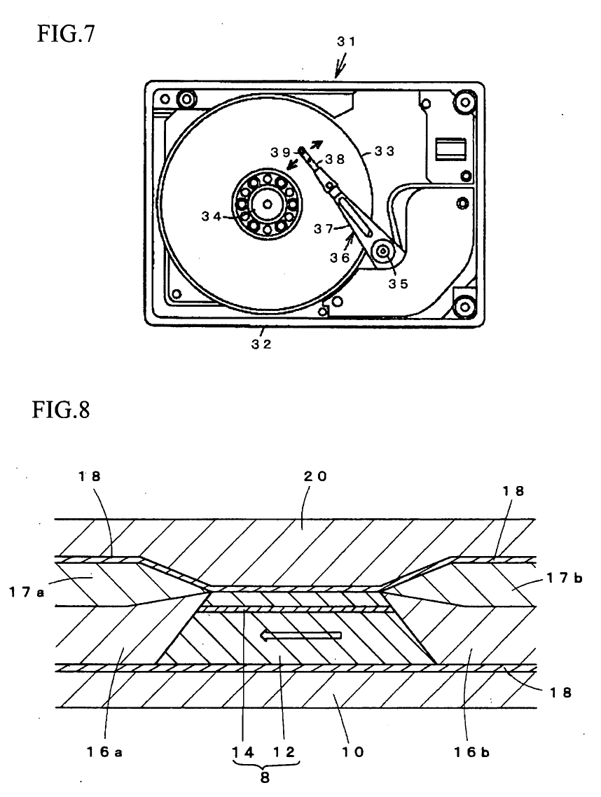

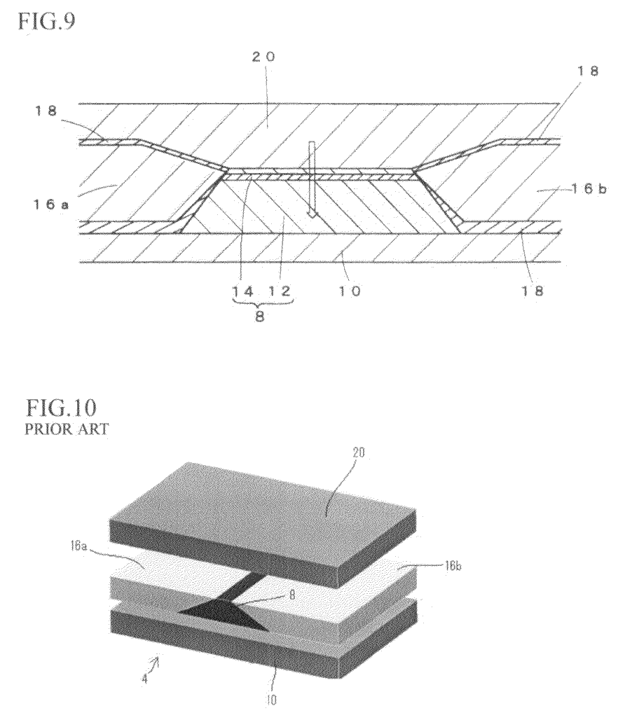

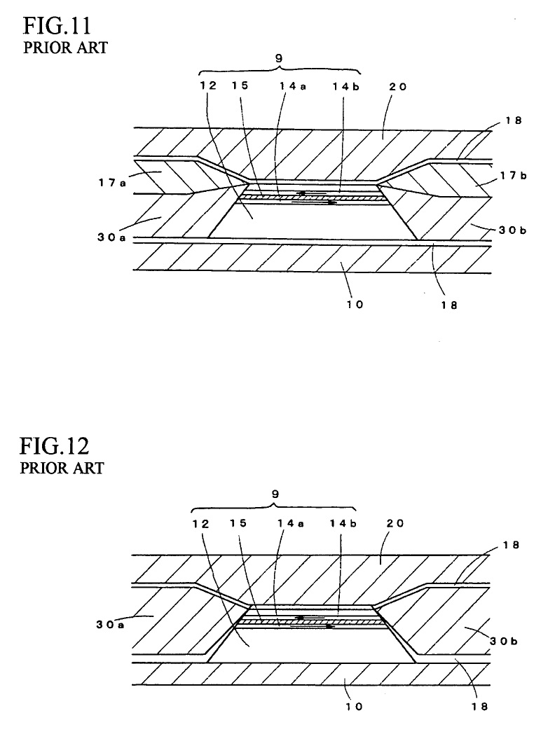

FIG. 7 illustrates the inner structure of a magnetic disk unit 31 serving as a magnetic recorder including the thin film magnetic head described above. A rectangular main body 32 of the magnetic disk unit 31 accommodates a magnetic disk 33 as a magnetic recording medium (recording medium). The magnetic disk 33 is mounted on a spindle motor 34. The spindle motor 34 rotates the magnetic disk 33 at a high speed, such as 7200 or 10000 rpm.

The main body 32 also accommodates a carriage 36, which swings on a spindle 35 disposed perpendicularly to the surface of the magnetic disk 33. The carriage 36 includes a rigid actuator arm 37 extending from the spindle 35 parallel to the surface of the magnetic disk 33 and an elastic suspension 38 in front of the actuator arm 37.

A thin film magnetic head 39 is disposed in front of the elastic suspension 38 while a floating plane 4 of the thin film magnetic head 39 faces the magnetic disk 33. The thin film magnetic head 39 is pressed against the magnetic disk 33 by the pressing force of the elastic suspension 38. The rotation of the magnetic disk 33 produces a current of air on the magnetic disk 33, giving buoyancy to the thin film magnetic head 39. The balance of the pressing force of the elastic suspension 38 and the buoyancy allows the thin film magnetic head 39 to plane over the magnetic disk 33 during the rotation of the magnetic disk 33.

While the thin film magnetic head 39 planes over the magnetic disk 33, the carriage 36 swings on the spindle 35 to move the thin film magnetic head 39 in the radial direction of the magnetic disk 33.

Through these movements, the thin film magnetic head 39 seeks a desired recording track on the magnetic disk 33. The carriage 36 may be driven by an actuator 43 (not shown), such as a voice coil motor (VCM).

In the thin film magnetic head 39 of the magnetic disk unit 31, ferromagnetic films 16a and 16b sandwich a magnetoresistance effect element 8 and control the magnetic domains of a free layer 14. The ferromagnetic films 16a and 16b is covered with an external-magnetic-field blockers 22a and 22b at the side of the floating plane 4 (the side of the magnetic disk 33). The external-magnetic-field blockers 22a and 22b can block a magnetic flux from a side track and thereby prevent the side reading. The resulting reproduction signal therefore does not include a noise caused by the side reading. Hence, the magnetic disk unit 31 has appropriate reading performance.

In addition, in a thin film magnetic head according to the present invention, the distance between edge 23a and edge 23b of external-magnetic-field blockers 22a and 22b can be controlled in response to the track width and the track pitch of a magnetic recording medium. This achieves the same effects as the adjustment of the core width of the magnetoresistance effect element 8.

Furthermore, in a thin film magnetic head according to the present invention, electrode films are covered with upper and lower shielding layers, unlike the magnetic head illustrated in FIG. 8 in which electroconductive electrode films (for example, formed of gold) are exposed at the floating plane. The upper and lower shielding layers can therefore prevent the short-circuit between electrode films caused by debris of an electrode film when a floating plane of a magnetic head comes into contact with a magnetic recording medium.

What is claimed is:

1. A thin film magnetic head comprising:
a magnetoresistance effect element;
ferromagnetic films sandwiching the magnetoresistance effect element and controlling the magnetic domains of the magnetoresistance effect element; and
external-magnetic-field blockers covering the ferromagnetic films at a floating plane side of the magnetoresistance effect element.

2. The thin film magnetic head according to claim 1, wherein the external-magnetic-field blockers have a wedge shape, and the tip among the tips of each of the external-magnetic-field blockers having the most acute angle faces the magnetoresistance effect element.

3. The thin film magnetic head according to claim 1, wherein the ferromagnetic films sandwich the magnetoresistance effect element also in the vicinity of the floating plane of the magnetoresistance effect element.

4. The thin film magnetic head according to claim 1, further comprising electrode films that sandwich the magnetoresistance effect element and are electrically connected with the magnetoresistance effect element,
wherein the external-magnetic-field blockers cover the electrode films at a floating plane side of the magnetoresistance effect element.

5. The thin film magnetic head according to claim 4, wherein the external-magnetic-field blockers are insulated from the electrode films.

6. A magnetic recorder for reading information from a recording medium using a thin film magnetic head comprising:
a magnetoresistance effect element;
ferromagnetic films sandwiching the magnetoresistance effect element and controlling the magnetic domains of the magnetoresistance effect element; and
external-magnetic-field blockers covering the ferromagnetic films at a floating plane side of the magnetoresistance effect element.

7. A method for manufacturing a thin film magnetic head, comprising the steps of:
producing a magnetoresistance effect element;
producing ferromagnetic films to sandwich the magnetoresistance effect element and control the magnetic domains of the magnetoresistance effect element;
producing external-magnetic-field blockers covering the ferromagnetic films at a floating plane side of the magnetoresistance effect element; and
exposing a floating plane of the magnetoresistance effect element by polishing.

8. The method for manufacturing a thin film magnetic head according to claim 7, wherein the step for producing external-magnetic-field blockers comprises removing portions of the ferromagnetic films in contact with the floating plane to form the external-magnetic-field blockers in the resulting spaces.
